(19) United States
(12) Patent Application Publication
(10) Pub. No.: US 2006/0124113 A1
(43) Pub. Date: Jun. 15, 2006

(54) Marine engine fuel cooling system

(76) Inventor: Forest G. Roberts SR., Fort Lauderdale, FL (US)

Correspondence Address: MORGAN LEWIS & BOCKIUS LLP, 1111 PENNSYLVANIA AVENUE NW, WASHINGTON, DC, 20004, US

(21) Appl. No.: 11/008,234

(22) Filed: Dec. 10, 2004

(51) Int. Cl. F02M 31/20

(52) U.S. Cl. 123/541

(57) ABSTRACT

A fuel cooling system for a marine inboard engine, including a fuel tank, a fuel supply conduit, and a heat exchanger. The fuel supply conduit includes first and second ends, and extends between the fuel tank and a fuel injection system for the engine. The heat exchanger is disposed intermediate the first and second ends of the fuel supply conduit, and includes a fuel passage in fluid communication with the fuel supply conduit, and a coolant passage in fluid communication with a coolant side of a closed-loop auxiliary cooling system.

### FIELD OF THE INVENTION

This invention relates generally to a fuel cooling system for an internal combustion engine, and more particularly to a fuel cooling system for a marine diesel inboard engine.

### BACKGROUND OF THE INVENTION

Fuel delivery systems for marine inboard diesel engines include a fuel tank, a fuel supply conduit, a fuel injection system including a fuel pump, and a fuel return conduit. Diesel fuel is supplied from the tank, through the supply conduit, and to the fuel injection system. Fuel is then injected into combustion cylinders of the diesel engine, mixed with air, and combusted. The fuel injection system requires a continuously circulating supply of fuel, whereby excess fuel that is not injected into the combustion cylinders is returned to the fuel tank via the fuel return conduit. This process is known as constant fuel re-circulation. A problem arises with constant fuel re-circulation systems because the heat emitted by the diesel engine is transferred to the re-circulated fuel returning to the fuel tank, thus raising the temperature of the fuel in the tank. Repeated cycles of fuel re-circulation further increase the temperature of the fuel in the tank. The elevated fuel temperature causes an array of problems including a decrease in engine efficiency, a decrease in power, an increase in wear on system parts such as the fuel pump, and an increase in exhaust emissions.

Accordingly, there have been attempts to lower the temperature of the fuel returning to the tank to avoid overheating the fuel in the fuel tank. A known attempt includes installing a heat exchanger in the fuel return conduit. The heat exchanger includes a fuel passage and a seawater passage, so that heat is transferred from the fuel to the seawater. However, fuel in fuel delivery systems having a seawater cooled heat exchanger in the fuel return conduit can still reach temperatures well in excess of the engine-manufacturer rated temperature of approximately 78° F.

It is believed that there is a need for a fuel cooler for a marine diesel inboard engine that maintains the temperature of the re-circulated fuel at or closer to the engine-manufacturer rated temperature.

### SUMMARY OF THE INVENTION

In one embodiment, the invention provides a fuel cooling system for a marine inboard engine, including a fuel tank, a fuel supply conduit, and a heat exchanger. The fuel supply conduit includes first and second ends, and extends between the fuel tank and a fuel injection system for the engine. The heat exchanger is disposed intermediate the first and second ends of the fuel supply conduit, and includes a fuel passage in fluid communication with the fuel supply conduit, and a coolant passage in fluid communication with a coolant side of a closed-loop auxiliary cooling system.

In another embodiment, the invention provides a fuel cooler for a marine diesel engine. The fuel cooler is adapted to be disposed in a fuel supply conduit that extends between a fuel tank and a fuel injection system for the engine. The fuel cooler includes a heat exchanger having a fuel passage for fluid communication with the fuel supply conduit, and a coolant passage for fluid communication with a chill water side of an auxiliary cooling system.

In yet another embodiment, the invention provides a method of cooling fuel for a marine inboard engine. The method includes flowing the fuel from a fuel tank through a first portion of a fuel supply conduit, flowing the fuel through a fuel passage in a heat exchanger, flowing chill water from a chill water side of an auxiliary cooling system through a coolant passage in the heat exchanger, and flowing the fuel through a second portion of the fuel supply conduit to a fuel injection system for the engine.

### BRIEF DESCRIPTION OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 is a schematic illustration of a fuel cooling system for a marine inboard engine, according to an embodiment of the invention.

FIG. 2 is a perspective view of a fuel cooler for a marine inboard engine, according to an embodiment of the invention.

FIG. 3 is a cross-sectional view of the fuel cooler in FIG. 2.

### DETAILED DESCRIPTION OF THE PREFERRED EMBODIMENTS

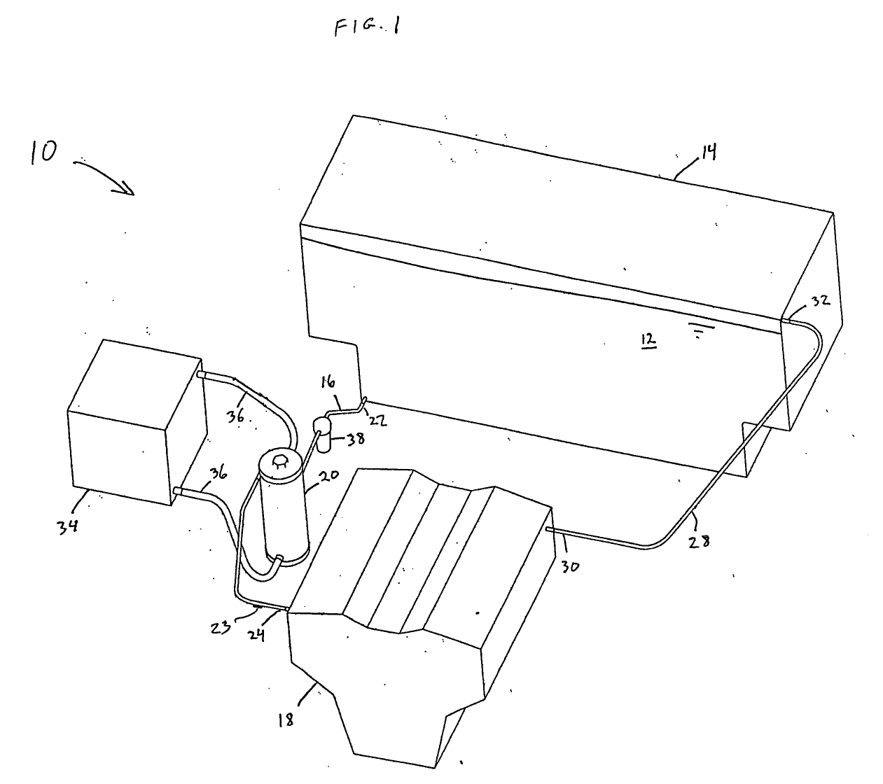

FIG. 1 schematically illustrates one embodiment of a fuel cooling system 10 for a marine inboard engine. In the embodiment, diesel fuel 12 is contained under atmospheric pressure in a fuel tank 14 that is typically disposed remote from a marine diesel inboard engine 18. A fuel supply conduit 16 may be connected to a lower portion of the fuel tank 14 at a first end 22, and is subject to the head pressure of the fuel 12 in the tank 14. A second end 24 of the fuel supply conduit 16 is in fluid communication with a fuel injector system (not shown) which may be mounted on the marine inboard diesel engine 18. A temperature sensor 23 may be disposed at second end 24 of the fuel supply conduit 16 for monitoring the temperature of the fuel 12 flowing through the fuel injector system. The fuel injector system includes a fuel pump (not shown). A fuel return conduit 28 is in fluid communication with a terminal portion of the fuel injector system at a first end 30, and is connected to an upper portion of the fuel tank 14 at a second end 32. A fuel cooler 20, described below in more detail, is disposed intermediate the first and second ends 22, 24 of fuel supply conduit 16, and includes a fuel passage in fluid communication with the fuel supply conduit 16. An auxiliary cooling system 34 includes a closed-loop chill water side 36 that is in fluid communication with a coolant passage in the fuel cooler 20. Auxiliary cooling system 34 may be the marine vessel's primary air-conditioning system having excess cooling capacity, an auxiliary cooling system dedicated to the fuel cooling system 10, or other closed-loop cooling systems aboard the marine vessel. A fuel filter 38 may be disposed in the fuel supply conduit 16 intermediate the first end 22 and the fuel cooler 20.

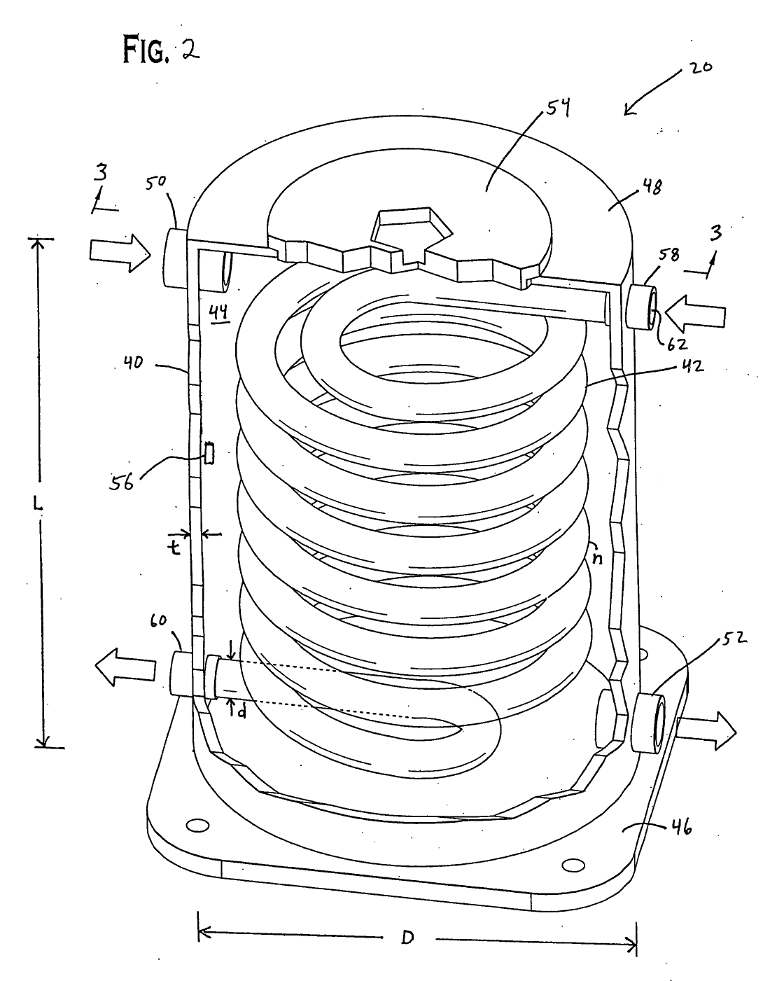

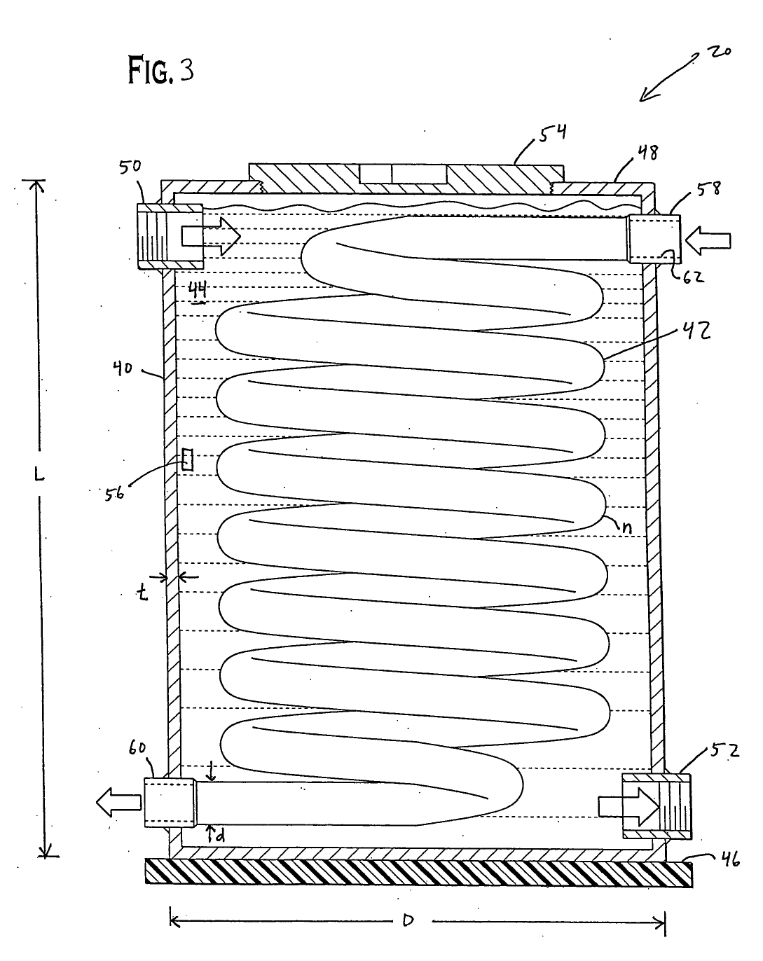

FIG. 2 illustrates a perspective view of the fuel cooler 20, according to an embodiment of the invention. FIG. 3 is a cross-sectional view of the fuel cooler in FIG. 2. Fuel cooler 20 is a shell and tube heat exchanger, having a shell 40 and a tube 42. Shell 40 is formed as a cylindrical tube made from a thermoplastic resin pipe such as poly-vinyl-chloride (PVC) pipe. Shell 40 includes a mounting plate 46 forming a fluid tight seal with a lower end of shell 40, and a cover plate 48 forming a fluid tight seal with an upper end of shell 40. Shell 40 has a diameter D of approximately 10 inches, a length L of approximately 14-18 inches, and a wall thickness t of approximately ¼ inch. Shell 40 is penetrated at a top portion by a 1 inch diameter fitting forming a coolant inlet 50, and is penetrated at a bottom portion by a 1 inch diameter fitting forming a coolant outlet 52. Thus, shell 40, mounting plate 46 and cover plate 48 define a coolant passage 44 disposed between coolant inlet 50 and coolant outlet 52. One or more temperature sensors 56 may be disposed in coolant passage 44 for monitoring the temperature of coolant flowing through the coolant passage 44. A removable plug 54 forms a fluid-tight threaded connection with cover plate 48 to provide access to the coolant passage 44 for inspection and cleaning. Of course, it is recognized that shell 40 may be formed of other suitable materials, as long as shell 40 forms a fluid-tight coolant passage 44. For example, shell 40 may be formed of a stainless steel pipe or a brass pipe. Moreover, shell 40 may be formed in shapes other than a cylinder, such as a box-shaped tank.

Tube 42 is housed within shell 40 and defines a fuel passage 62 between a fuel inlet 58 and a fuel outlet 60. Tube 42 is formed from a copper pipe having a diameter d of approximately ¾ inches and a straight length of approximately 18-20 feet. The 18-20 foot long section of pipe is configured as a helix having multiple coils n to increase contact of an outer surface of tube 42 with coolant in the 14-18 inch long shell 40. Of course, it is recognized that tube 42 may be formed of other suitable materials, as long as tube 42 forms a fluid-tight fuel passage and is compatible with the fuel. For example, tube 42 may be formed from a titanium pipe. Moreover, tube 42 may be formed in shapes other than a helix. For example, the fuel cooler 20 may be configured as a single pass shell and tube heat exchanger with parallel flow or counter flow, a multiple pass heat exchanger, or a cross-flow heat exchanger.

In operation, the fuel pump draws fuel 12 from the fuel tank 14 via the fuel supply conduit 16 and the fuel passage 62 of the fuel cooler 20, and pumps the fuel through the fuel injector system 26 into combustion cylinders of the marine diesel engine 18. As the fuel flows through fuel passage 62, heat is transferred from the fuel to chill water flowing through the coolant passage by conduction through tube 42. The fuel pump continuously pumps fuel through the fuel injector system 26 regardless of the marine diesel engine's demand for fuel. Pressurized fuel that is not pumped through the fuel injectors into the combustion cylinders of the marine diesel engine is re-circulated through the fuel return conduit 28 back to the fuel tank 14. However, heat is transferred from the marine diesel engine to the re-circulated fuel, thus increasing the temperature of the fuel 12 in the fuel tank 14. Hot weather or very warm sea water can exacerbate the problem by further raising the temperature of the fuel. This added heat is removed by the fuel cooler 20 before the fuel is again drawn into the fuel injection system 26 by the fuel pump. As described above, chill water flows through the coolant passage 44 to cool the fuel. However, other fluids may be used to cool the fuel, so long as the temperature of the cooling fluid is lower than the temperature of the fuel.

Without a fuel cooler 20, the temperature of the fuel in the fuel tank may reach in excess of 120-140° F. after re-circulating for several hours. Such temperatures are well in excess of a typical engine-manufacturer rated temperature of approximately 78° F. With the fuel cooler 20 flowing chill water at an inlet temperature of approximately 46-50° F., the temperature of the fuel can be reduced by approximately 20-25%, or to approximately 90-112° F. The temperature of the fuel can be further reduced to approximately 78° F. by having more than one fuel cooler 20 in series in the fuel supply conduit 16, a dual-stage fuel cooler in the fuel supply conduit 16, and/or an additional fuel cooler in the fuel return conduit 28. The fuel temperature flowing into the combustion cylinders of the marine diesel engine may be monitored by a temperature sensor, and adjusted by increasing or decreasing the temperature of the chill water.

Numerous advantages are achieved by the embodiments of the invention. For example, by lowering the temperature of the fuel as the fuel enters the combustion cylinders of the marine diesel engine, fuel efficiency is increased, power is increased, and exhaust emissions are decreased. Moreover, as the temperature of the fuel is decreased, the lubrication properties of the fuel are improved, thus prolonging the life-cycle of system components such as the fuel pump.

While the invention has been disclosed with reference to certain embodiments, numerous modifications, alterations, and changes to the described embodiments are possible without departing from the spirit and scope of the invention, as defined in the appended claims and their equivalents thereof. Accordingly, it is intended that the invention not be limited to the described embodiments, but that it have the full scope defined by the language of the following claims.

1. A fuel cooling system for a marine inboard diesel engine, comprising:
a fuel tank;
a fuel supply conduit having first and second ends and extending between the fuel tank and a fuel injection system for the marine inboard diesel engine;
a heat exchanger disposed intermediate the first and second ends of the fuel supply conduit, the heat exchanger including a fuel passage in fluid communication with the fuel supply conduit, and a coolant passage in fluid communication with a coolant side of a closed-loop auxiliary cooling system; and
a fuel return conduit extending between the fuel injection system and the fuel tank.

2. The fuel cooling system of claim 1, wherein the coolant side of the closed-loop auxiliary cooling system comprises a chill water side.

3. The fuel cooling system of claim 2, wherein the auxiliary cooling system comprises an air conditioning system.

4. The fuel cooling system of claim 2, wherein the marine inboard engine being a diesel engine.

5. The fuel cooling system of claim 4, comprising:
a fuel filter disposed intermediate the fuel tank and the heat exchanger; and
a fuel pump disposed proximate the fuel injection system.

6. The fuel cooling system of claim 2, wherein
the heat exchanger is a shell and tube heat exchanger,
the tube forms a helix and defines the fuel passage,
the shell forms a cylinder and defines the coolant passage, and
the shell houses the tube.

7. The fuel cooling system of claim 6, wherein
the shell is formed of a PVC pipe having a diameter of approximately 10 inches, a length of approximately 14-18 inches, and a wall thickness of approximately ¼ inch, the shell including a chill water inlet having a diameter of approximately 1 inch and a chill water outlet having a diameter of approximately 1 inch, the shell including a removable cover for inspection and cleaning; and
the tube is formed of a copper pipe having a diameter of approximately ¾ inches and a straight-length of approximately 18-20 feet.

8. The fuel cooling system of claim 6, wherein
the shell is formed of one of a PVC pipe, a stainless steel pipe, and a brass pipe; and
the tube is formed of one of a copper pipe and a titanium pipe.

9. A fuel cooler for a marine diesel engine adapted to be disposed in a fuel supply conduit extending between a fuel tank and a fuel injection system for the marine diesel engine, comprising:
a heat exchanger having a fuel passage for fluid communication with the fuel supply conduit extending between the fuel tank and the fuel injection system of the marine diesel engine, and a coolant passage for fluid communication with a coolant side of a closed-loop auxiliary cooling system.

10. A method of decreasing the temperature of fuel supplied to a marine inboard diesel engine, comprising:
flowing the fuel from a fuel tank through a first portion of a fuel supply conduit;
flowing the fuel through a fuel passage in a heat exchanger;
flowing coolant from a coolant side of a closed-loop auxiliary cooling system through a coolant passage in the heat exchanger, thereby decreasing the temperature of the fuel; and
flowing the fuel through a second portion of the fuel supply conduit to a fuel injection system for the marine inboard diesel engine; and
flowing uncombusted fuel from the fuel injection system through a fuel return conduit to the fuel tank.

11. (canceled)

12. The method of claim 10, comprising:
the coolant having a temperature of approximately 46-50° F. at an inlet of the heat exchanger coolant passage; and
the fuel having a temperature of approximately 90-112° F. at an outlet of the heat exchanger fuel passage.

13. The method of claim 10, comprising:
the fuel having a temperature of approximately 78° F. at an outlet of the heat exchanger fuel passage.

14. The method of claim 10, comprising:
monitoring the temperature of the fuel flowing through the second portion of the fuel supply conduit; and
adjusting the temperature of the coolant.

15. The method of claim 10, wherein decreasing the temperature of the fuel supplied to the marine inboard diesel engine increases the fuel economy of said engine.
